(19) United States
(12) Patent Application Publication
(10) Pub. No.: US 2005/0233767 A1
(43) Pub. Date: Oct. 20, 2005

(54) Method, system and computer program for interfacing a mobile device to a configurator and/or backend applications

(76) Inventors: Srirama Ayyeppen, Addison, TX (US); Sunil Annam, Dallas, TX (US)

Correspondence Address: JACKSON WALKER LLP, 2435 NORTH CENTRAL EXPRESSWAY, SUITE 600, RICHARDSON, TX, 75080, US

(21) Appl. No.: 11/085,981

(22) Filed: Mar. 22, 2005

Related U.S. Application Data
(60) Provisional application No. 60/555,151, filed on Mar. 22, 2004.

(51) Int. Cl. H04B 1/38

(52) U.S. Cl. 455/557; 455/550.1

(57) ABSTRACT

What is disclosed is a method, system and computer program adapted to interface a mobile device to a wireless mobile configurator and/or an enterprise's network platform or backend. The mobile device, as interfaced, and enables sales, manufacturing and service teams to develop quotes, create system configurations, process orders and check inventory at any time and from any location.

### CROSS REFERENCE TO RELATED APPLICATIONS; CLAIMS OF PRIORITY

This application is related to U.S. provisional patent application No. 60/555,151 filed Mar. 22, 2004, entitled “A WIRELESS CONFIGURATOR”, the entire contents of which are incorporated herein by this reference. The Applicants hereby claim the benefits of this provisional application under 35 U.S.C. Section 119(e)

### STATEMENT REGARDING FEDERALLY SPONSORED RESEARCH OR DEVELOPMENT

No federal grants or funds were used in the development of the present invention.

### FIELD OF THE INVENTION

The present invention relates to methods, systems and computer programs for interfacing portable devices to backend applications resident on a centralized server.

### BACKGROUND OF THE INVENTION

In the past few years there has been an explosive growth in the Internet, particularly the world wide web (“WWW”) facilities of the Internet. When used herein, the term Internet shall mean the Internet and its facilities, such as the WWW, as well as similar computer network facilities, protocols and transmission means. There has also been significant growth in the use of portable mobile devices such as personal digital assistants (“PDAs”) and the like. With more and more PDAs having wireless access to the Internet, attempts re big made to provide users of mobile devices with access to information that is resident on networked servers and backend systems through the Internet.

Certain terms are used throughout the following description and claims to refer to particular system components. As one skilled in the art will appreciate, computer companies may refer to a component and sub-components by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either a direct or indirect, wired or wireless, electrical connection. Thus, if a first device couples to a second device, that connection may be through a direct electrical connection, or through an indirect electrical connection via other devices and connections. In addition, no distinction is made between a “processor,” “microprocessor,” “microcontroller,” or “central processing unit” (“CPU”) for purposes of this disclosure. The term mobile configurator, wireless configurator and wireless mobile configurator are used synonymously herein, unless the context clearly indicates otherwise. To the extent that any term is not specially defined in this specification, the intent is that the term is to be given its plain and ordinary meaning.

### SUMMARY OF INVENTION

The present invention relates to a method, system and computer program for enabling portable devices running client software used, for example, by mobile users, to access and transmit information on backend applications resident on a centralized server.

An object of the present invention is to provide a method, system and computer program adapted to give users of portable devices access to real time and latent information contained on backend servers.

Another object of the present invention is to provide a method, system and computer program adapted to give users of portable devices a means of transmitting information from portable devices to a backend server in order to update information contained on the backend server.

A further object of the present invention is to provide a method, system and computer program that is able to update information from a portable device to a backend in real-time or on a latent basis.

Other objects and advantages of the present invention will be set forth in part in the description and the drawings which follow, and, in part, will be obvious from the description or may be learned by practice of the invention. The present invention will now be described with reference to the following drawings, in which like reference numbers denote the same element throughout.

### BRIEF DESCRIPTION OF THE DRAWINGS

FIG. 1 is an illustration of a system which enables mobile devices to access and transmit information through a mobile gateway having a mobile configurator to backend applications;

FIG. 2 displays how the XML from the gateway is read and processed by the renderer object.

FIG. 3 is an screen shot of a mobile device user interface (“UI”) illustrating an aspect of the present invention;

FIG. 4 is a screen shot of a mobile device UI illustrating another aspect of the present invention;

FIG. 5 is a screen shot of a mobile device UI illustrating another aspect of the present invention;

FIG. 6 is a screen shot of a mobile device UI illustrating another aspect of the present invention;

FIG. 7 is a screen shot of a mobile device UI illustrating another aspect of the present invention;

FIG. 8 is a screen shot of a mobile device UI illustrating another aspect of the present invention;

FIG. 9 is a screen shot of a mobile device UI illustrating another aspect of the present invention;

FIG. 10 is a screen shot of a mobile device UI illustrating another aspect of the present invention;

FIG. 11 is a screen shot of a mobile device UI illustrating another aspect of the present invention;

FIG. 12 is a screen shot of a mobile device UI illustrating another aspect of the present invention;

FIG. 13 is a screen shot of a mobile device UI illustrating another aspect of the present invention;

FIG. 14 is a screen shot of a mobile device UI illustrating another aspect of the present invention;

FIG. 15 is a screen shot of a mobile device UI illustrating another aspect of the present invention;

FIG. 16 is a screen shot of a mobile device UI illustrating another aspect of the present invention;

FIG. 17 is a screen shot of a mobile device UI illustrating another aspect of the present invention;

FIG. 18 is a screen shot of a mobile device UI illustrating another aspect of the present invention;

FIG. 19 is a screen shot of a mobile device UI illustrating another aspect of the present invention;

FIG. 20 is a screen shot of a mobile device UI illustrating another aspect of the present invention;

FIG. 21 is a screen shot of a mobile device UI illustrating another aspect of the present invention;

FIG. 22 is a screen shot of a mobile device UI illustrating another aspect of the present invention;

FIG. 23 is a screen shot of a mobile device UI illustrating another aspect of the present invention;

FIG. 24 is a screen shot of a mobile device UI illustrating another aspect of the present invention;

FIG. 25 is a screen shot of a mobile device UI illustrating another aspect of the present invention;

FIG. 26 is a screen shot of a mobile device UI illustrating another aspect of the present invention;

FIG. 27 is a screen shot of a mobile device UI illustrating another aspect of the present invention;

FIG. 28 is a screen shot of a mobile device UI illustrating another aspect of the present invention;

FIG. 29 is a screen shot of a mobile device UI illustrating another aspect of the present invention;

FIG. 30 is a screen shot of a mobile device UI illustrating another aspect of the present invention;

FIG. 31 is a screen shot of a mobile device UI illustrating another aspect of the present invention;

FIG. 32 is a screen shot of a mobile device UI illustrating another aspect of the present invention;

FIG. 33 is a screen shot of a mobile device UI illustrating another aspect of the present invention;

FIG. 34 is a screen shot of a mobile device UI illustrating another aspect of the present invention;

FIG. 35 is a screen shot of a mobile device UI illustrating another aspect of the present invention;

FIG. 36 is a screen shot of a mobile device UI illustrating another aspect of the present invention;

FIG. 37 is a screen shot of a mobile device UI illustrating another aspect of the present invention;

FIG. 38 is a screen shot of a mobile device UI illustrating another aspect of the present invention;

FIG. 39 is a screen shot of a mobile device UI illustrating another aspect of the present invention;

FIG. 40 is a screen shot of a mobile device UI illustrating another aspect of the present invention;

FIG. 41 is a screen shot of a mobile device UI illustrating another aspect of the present invention;

FIG. 42 is a screen shot of a mobile device UI illustrating another aspect of the present invention;

FIG. 43 is a screen shot of a mobile device UI illustrating another aspect of the present invention;

FIG. 44 is a screen shot of a mobile device UI illustrating another aspect of the present invention;

FIG. 45 is a screen shot of a mobile device UI illustrating another aspect of the present invention;

FIG. 46 is a screen shot of a mobile device UI illustrating another aspect of the present invention;

FIG. 47 is a screen shot of a mobile device UI illustrating another aspect of the present invention;

FIG. 48 is a screen shot of a mobile device UI illustrating another aspect of the present invention;

FIG. 49 is a screen shot of a mobile device UI illustrating another aspect of the present invention;

FIG. 50 is a screen shot of a mobile device UI illustrating another aspect of the present invention; and

FIG. 51 is a screen shot of a mobile device UI illustrating another aspect of the present invention.

### DETAILED DESCRIPTION OF THE PRESENT INVENTION

The present invention extends an enterprise's network platform or backend to any portable device, including wired or wireless device, and enables sales, manufacturing and service teams to develop quotes, create system configurations, process orders and check inventory at any time and from any location.

The present invention, for example, can enable a mobile users, such as a mobile sales, service or manufacturing personnel, for example, the ability to immediately develop a quote at a customer site, check inventory availability, place an order and provide a shipping date to the customer. By using the present invention wirelessly, mobile users can provide the information to customers on availability and delivery dates plus generate configurations and costs almost instantly, shortening the sales cycle and eliminating delays in fulfillment. The present invention comprises mobile applications based on business processes that deploy a company's platform to the mobile workforce without the need for a heavy client. In operation, users download the user UI appropriate for their portable device one time, and they are wirelessly integrated to the core platform.

The present invention enables discrete functions to be performed in the field while streamlining overall corporate processes. The present invention optimizes business processes by giving the mobile user needed functionality in a manner that optimizes the process and eliminates duplicate data entry. By utilizing the present invention, a task performed in the field is completed one time. A quote generated in the field is accurate in real-time. Service call reports are completed when the work is done, not afterwards. The present invention advantageously reduces the sales cycle, decreases error rates and increases worker productivity. In contrast, conventional stand-alone mobile applications are not integrated with backend enterprise applications, or require extensive consulting to integrate.

There are three software components of the present invention, the mobile extensions, mobile gateway and mobile client. The mobile extensions provide the extensions necessary to effectively mobilize backend applications, such as those provided by enterprise software developers. The mobile extensions, together with the mobile gateway and mobile client software provide users seamless, secure information flow between the device and back-end applications.

The mobile gateway comprises a secure, IP messaging gateway for managing device connections and an effective flow between mobile clients and backend systems. The mobile gateway ensures enterprise data is protected while traveling over wireless networks and the corporate network remains secure through user authentication. The mobile gateways also validate data and devices prior to gaining access to critical information systems.

The mobile client is based on a portable device OS platform, including, for example, Palm OS or PocketPC. One embodiment of the mobile client of the present invention devices is a Java-based client application that securely manages communications between the device and the mobile gateway.

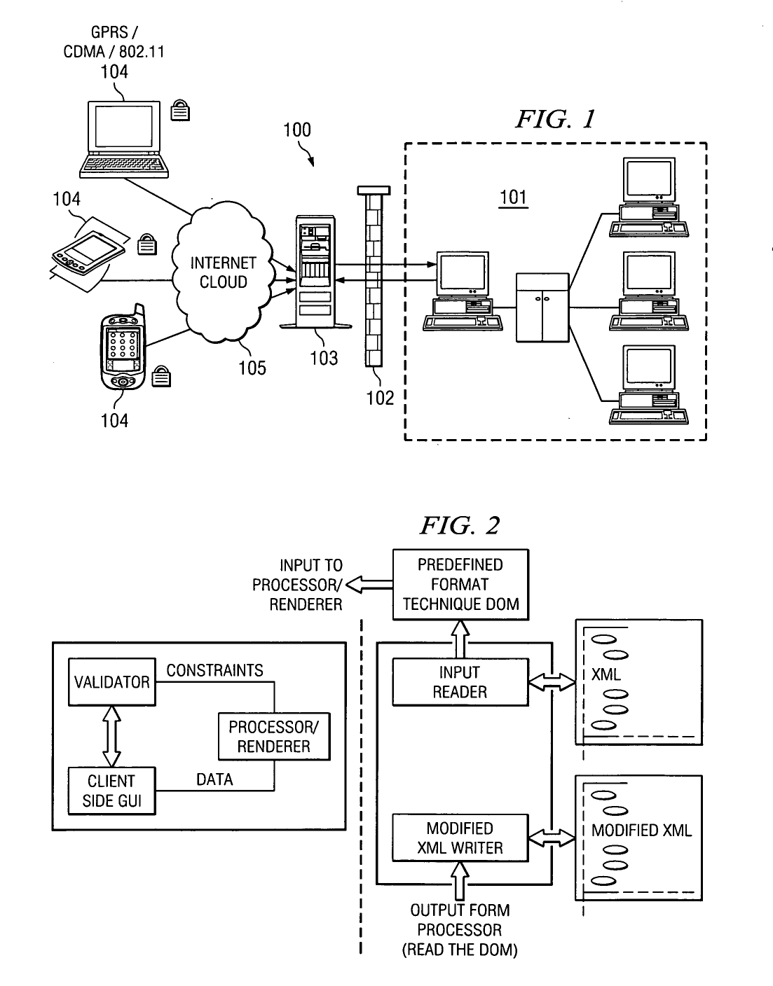

Referring now to FIG. 1, a framework or system 100 implementing the present invention is shown. Generally, as seen therein, backend 101 comprises the backend enterprise applications. These applications may be sales force business process applications, product configurations, shop floor control, business intelligence applications and the like. The backend business applications 101 communicate through firewall 102 to a mobile gateway 103. Mobile gateway 103 comprises an access gateway for mobile clients 104, provides authentication and device/data validation and security key distribution. Mobile clients 104 intercommunicate with mobile gateway 103 through the internet 105. Mobile clients 104 support a variety of platforms, such as Palm OS and PocketPC. The Java based client supports multiple devices and provides for secure data storage and transmission. As one skilled in the art can appreciate, the use of the terms mobile gateway may refer to the physical hardware running the mobile gateway software as well as the mobile gateway software itself and the term mobile client and mobile device may refer to the physical device running the mobile client software as well as the mobile client software itself, each as the context of the use of the term requires.

As seen in FIG. 1, the framework can be divided into 4 sections, device application, mobile gateway, messaging between the device and the gateway and backend business logic interface. The mobile client 104 on the network which communicates with the mobile gateway 103 is loaded with a application, for example, a java application, that is developed with the standards based on the application framework. This includes how report screens are defined, what invokes a report and what initiates a request to the mobile gateway 103. The mobile gateway 103 serves as an entry point for the messages generated by the mobile device 104. These messages are validated, checked for errors during transmission and parsed for valid requests. The requests on the mobile gateway 103 can use a configuration database mapped to backed business logic that is performed on approval.

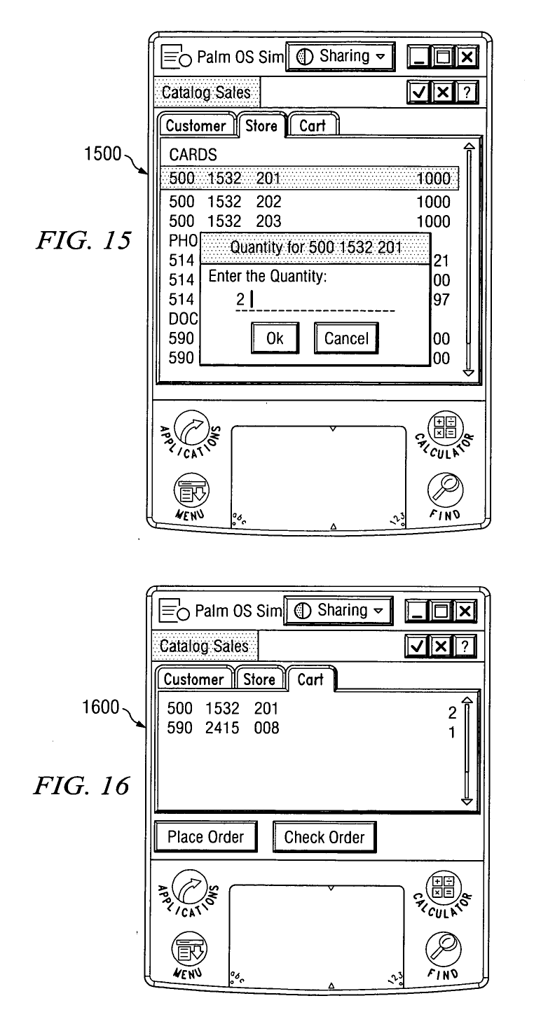

The message framework defines, what is required to be sent from the mobile device 104 to the mobile gateway 103, in order to attain authentication to send and receive data. The message framework also defines the protocol, the list of messages, the message flow and what is sent and received for every process. These may be defined in XML as seen in FIG. 15. In order to message in XML, the server and the client must have an XML parser engine to parse the XML and understand the message.

The message framework interfaces the mobile gateway 103 with the backend 101 which can comprise an ERP/database with smart links to functionality. The interfaces can be designed as links, for example to Webservices, SOAP, Corba or COM interface. The interfaces are invoked which execute the required functionality on the server and hands over the results of the transaction back to the messaging framework through the mobile gateway 103. This framework makes the results available on the mobile device 104, which is parsed at the mobile device 104 end to extract required information.

CZQueue is a software component that which resides in the middle tier of the wireless mobile configurator, between mobile gateway 103 and the configurator engine. CZQueue comprises a model loader, asynchronous messaging client and a pool of model contexts. Upon startup, CZQueue initializes the configurator engine and creates pool of model contexts. The mobile gateway 103 receives inputs from mobile devices 104 and sends them to CZQueue. When a mobile device 104 sends a sync request to configure a product or a service or the like, CZQueue loads the appropriate model using a model context from the pool. The model context is associated with the client device for one session. For each user action (select/unselect one or more options or change in quantity) using the UI, the mobile device 104 generates a request to validate user inputs. CZQueue maps each user request against the corresponding model context and updates the model inputs. The configurator engine validates the change in input and either sets an error condition or generates outputs as per defined rules. CZQueue retrieves the result set and sends a reply to mobile device 104 via the mobile gateway 103. When multiple mobile devices 104 are sending requests, each mobile device will have a separate model context in CZQueue. Once a maximum number of model contexts is consumed from the pool, CZQueue creates more contexts dynamically.

In operation, CZQueue operates as follows:
1. CZQueue initializes configurator engine;
2. CZQueue creates a model context pool;
3. CZQueue waits in a wait state for a service request from a mobile gateway;
4. Once a request is received, CZQueue parses the service request and retrieves the model id to be loaded;
5. If the service request is the first request from a device, it passes the model id to the model loader;
6. If the model with the model id does not exist, a reply with an error code and an error message is sent;
7. If the model id is a valid id, the model loader consumes one model context from the pool and loads the model with requested id;
8. If the request is for an existing configuration, the model loader loads the previously-stored configuration;
9. CZQueue sends a reply message to the mobile gateway indicating that the requested model/configuration successfully loaded;
10. In the event of an error, CZQueue sends an error message and error code back to the mobile device via the mobile gateway;

The following events occur if the user changes an input to the model:
1. The mobile device passes each value change (Boolean or quantitative) to the mobile gateway, which in turns sends the message to CZQueue;
2. CZQueue parses each packet it receives and sends a value change request to the associated model context;
3. The model context feeds user inputs to the loaded model;
4. The configurator engine validates user inputs and sets of rules are fired/applied based on predefined constraints;
5. If users inputs are violating any constraints set by the rules developer, the configurator engine sets an error condition;
6. If the user inputs are not violating any rules, the configurator engine brings the model to the new state;
7. If CZQueue detects an error condition in a model, it rolls back the last transaction and sends error an message back to the mobile device;
8. If there are no errors, CZQueue sends the model state information and value set to the mobile device;
9. The mobile device displays the results on screen and let user makes new selections.

When a user logs out the model context is returned back to the pool.

If there is no activity on particular model context for a predefined time, the model context is returned back to the pool.

CZQueue is adapted to receive sync messages from a message server. Multiple mobile gateways can be associated with the same message server. In addition, there can be multiple CZQueues running on one or more servers communicating with one message server. CZQueue can comprise a single executable and a configuration file, installable from a folder from where the configurator engine is available. CZQueue requires the configuration file present in the same folder.

As detailed above, the mobile applications extension software enables a variety of actions via the UI and the mobile device. These may include the following screens and access to the following information: Login Screen, Main Menu Screen, Business Intelligence Screen, Customers, Catalog Sales, Configured Sales Screen, Order Process and Management Screen, Sales Order Jobs, Bill of Material (“BOM”) Inquiry, Inventory Inquiry and Time capture and Projects.

One embodiment of the mobile gateway that enables access to the foregoing screens and information includes the following configuration set-up:

<palmproxy_config>
<service>
<request_type>JOBALERTS</request_type>
<service_type>WEBSERVICE</service_type>
<target_endpoint>http://islinux:8080/axis/JobAlertServer.jws</target_endpoint>
<operation_name>getAlerts</operation_name>
<parameters>
<param>
<param_name>param1</param_name>
<param_type>String</param_type>
</param>
</parameters>
<return>
<return_type>String</retum_type>
</return>
</service>
<service>
<request_type>Disc_I_XML</request_type>
<service_type>WEBSERVICE</service_type>
<target_endpoint>http://localhost:8080/axis/DisRecvXml.jws</target_endpoint>
<operation_name>SendXML</operation_name>
<parameters>
<param>
<param_name>param1</param_name>
<param_type>String</param_type>
</param>
<param>
<param_name>param2</param_name>
<param_type>String</param_type>
</param>
<param>
<param_name>param3</param_name>
<param_type>String</param_type>
</param>
</parameters>
<return>
<return_type>String</return_type>
</return>
</service>
</palmproxy_config>

The above is but one example of a mobile proxy gateway configuration object. This information is created to configure the gateway the process the request coming in from the mobile device.

Definitions of each node include the following:

The request_type is the actual request that is sent by the mobile device. Examples of this information include GET_JOBALERTS, GET_SALESORDERS, GET_INVENTORY. This assists the mobile gateway in deciding which service to fork to.

The service_type states what type of service is configured for this request. The list of values include: WEBSERVICE which is information is forked to a webservice call described by the target_endpoint; COMOBJECT which is information forked to a comobject call described by the target_endpoint; CORBAOBJECT which is information forked to a CORBA object call described by the target_endpoint; JNICALL which is information forked to a JNI call described by the target_endpoint and REROUTE which is information automatically rerouted to another proxy that receives and processes the request. In this manner it is possible to cascade multiple servers in high-traffic environment. Other values can be used to describe methods to connect other disparate technologies to the gateway.

The target_endpoint is the link describing where the service exists to execute, process results and stream it back to the mobile device. One target_endpoint may contain multiple operations. This helps to choose the operation from the collection to execute to retrieve the results.

Param_name is the name of the parameter as described in the function. This is matched with the data coming through the MCF format (described below) to pass on to the operation

Param_type is the type of the parameter as described in the function.

Return_type is the type of the data that is returned back to the device. Usually this is a string value containing XML. The XML document in the format shown below is sent from the applications using socket connections. This instructs the mobile gateway to look at the marker (which can contain both ASCII or BINARY content) to review the request type. Based on the request_type the application forks into the respective call that is read from the proxy_config.

<mcf type=“request”name=“disc_i_xml”>
<identifier>000001<identifier>
<source>“PDA1”</source>
<time stamp date=“03/18/04”time=“10:13:30”></time_stamp>
<marker>
<request_type>JOBALERTS</request_type>
</marker>
</mobile_communication_format>

The <marker> tag refers to the start of the XML document. The XML document can contain any other node not displayed here that is relevant to the call actually being made.

To setup the mobile gateway to enable the application extension, the following steps are generally followed:

First, build the implantation object of the logic. An implantation object can be a webservice using AXIS/SOAP/.NET, a COMOBJECT, a CORBAOBJECT or a native interface like JNI/DLL. Build the service in one of the above methodologies based on the server and application restrictions of the target application to be extended. Based on the implementation the object can be placed in a supporting container either webservice container for AXIS or NET server.

Second, the gateway configuration file is setup using the above technique to fork to this implantation object upon sensing a request to perform a given task.

Third, build a mobile Mmdule to send MCF xml. On the mobile application front, develop the modules that send the MCF request based on which modules invoke it to communicate with the gateway. These modules should exist on its own that is reusable by other modules.

Fourth, build the optimal mobile screen to support sending the data through MCF format. This should include the XML packet transformer, display renderer and ui generator.

A sample of XML code that is generated by the server is provided as follows:

<Disc_I_XML>
<Customer></Customer>
<Configuration></Configuration>
<ModelType>6501</ModelType>
<UI_DEF_ID>123</UI_DEF_ID>
<PUBLICATION_ID>23433<?PUBLICATION_ID>
LConfigId></ConfigId>
<LRevNbr></RevNbr>
<GConfigId></ConfigId>
<GRevNbr></RevNbr>
<CreatedOn></CreatedOn>
<ModOn></ModOn>
<Nodes>

<Node>

<NodeType>PRODUCT</NodeType>
<Name>Fiber Router</Name>
<ParentComponentId>0</ParentComponentId>
<ComponentId>1</ComponentId>
<Min>1</Min>
<Max>5</Max>

</Node>

<Node>

<NodeType>COMPONENT</NodeType>
<Name>Settings one</Name>
<ParentComponentId>1</ParentComponentId>
<ComponentId>11</ComponentId>
<Min>1</Min>
<Max>5</Max>

</Node>

<Node>

<NodeType>OPTIONS</NodeType>
<Name>Fiber Mode</Name>
<ParentComponentId>11</ParentComponentId>
<ComponentId>111</ComponentId>
<Required>1 </Required>

<Min>0</Min>
<Max>1</Max>
<Values>

<Value>SingleMode</Value>
<Value>Multimode</Value>

</Values>

<Node>
<Node>

<NodeType>INTEGER</NodeType>
<Name>Card Count</Name>
<ParentComponentId>11</ParentComponentId>
<ComponentId>112</ComponentId>
<Required>1<Required>
<Values

<Value>0</Value>

</Values>

</Node>
<Node>

<NodeType>STRING</NodeType>
<Name>Location Name</Name>
<ParentComponentId>11</ParentComponentId>
<ComponentId>113</ComponentId>
<Required>1</Required>
<Values

<Value>xyz</Value>

</Values>

</Node>
<Node>

<NodeType>DECIMAL</NodeType>
<Name>Frequency</Name>
<ParentComponentId>11</ParentComponentId>
<ComponentId>114</ComponentId>
<Required>1</Required>
<Values

<Value>1.34</Value>

<Values>

</Node>
<Node>

<NodeType>BOOL</NodeType>
<Name>Say Yes or No</Name>
<ParentComponentId>11</ParentComponentId>
<ComponentId>114</ComponentId>
<Required>0</Required>
<Values

<Value>T</Value>

</Values>

</Node>

</Nodes>
</Disc_I_XML>

FIG. 2 displays how the XML from the gateway is read and processed by the renderer object.

After executing the function call, the mobile gateway packages the data into a MCF return packet and returns the data back to the device. The XML format data is parsed and transformed into the mobile display object to display in the device.

Sample code for Sales Order Jobs is as follows:

<mcf type=“response”name=“job_1”>
<identifier>000001</identifier>
<source>“GW”</source>
<time_stamp date=“03/18/04”time=“10:13:30”></time_stamp>
<marker>
<request_type>sojobs</request_type>
<jobs>
<job>
<wip>30434</wip>
<item>577857</item>
<status>RLSD</status>
<assy>M6500MODE*54296</assy>
</job>
<job>
<wip>30432</wip>
<item>577856</item>
<status>RLSD</status>
<assy>M6500MODE*54294</assy>
</job>
</jobs>
</marker.

Similarly all other request will have their own marker payload in the outbound packet with its own response component

Sample code for bills of materials is as follows:

<born partNumber=“885 0005 305”>
<part partno=“300 0325 001” Desc=“CARD,STE/OPX ANALOG LINE,
16 PORT SVC/57832” Qty=“1”></part>
<part partno=“612 0011 003” Desc=“LICENSE,CARD,STE/OPX,16
PORT W/INFO LINK CABLE W/LICENSE(ANALOG LINE/OFF
PREMISES EXTENSION)”Qty=“1”></part>
<part partno=“120 0025 002”Desc=“FUSE ASSY,TRUNK BLOCK,110
BLOCK,AT&T” Qty=“16”>/part>
<part partno=“400 1533 002”Desc=“PANEL,TELCO,INTERFACE
SHELF GENERAL” Qty=“1”></part>
<part partno=“500 1681 001”Desc=“KIT,LINE FILTER”Qty=“1”></part>
</bom>

Sample code for Inventory Check: Items on Hand is as follows:

<inv>
<part part_no=“MNHR6149QAAA” Qty=“5008”></part>
<part part_no=“MNHR6153AAAA” Qty=“5013”></part>
<part part_no=“MNHJ4256DAAA” Qty=“4988”></part>
<part part_no=“HW0532A” Qty=“4990”></part>
</mv>

Sample code for Addresses is as follows:

<addresses customerName=“ALCOA”>
<address line1=“4879 STATE STREET,DAVENPORT IA-52722”
Ship=“P”Bill=“P”>5344</address>
<address linel=“DAVENPORT WORKS,BETTENDORF IA-52722”
Ship=“Y”Bill=“”>5361</address>
<address line1 =“PO BOX 1755 ,PITTSBURGH PA-15230-1755”
Ship“”Bill=“Y”>10962</address>
</addresses>

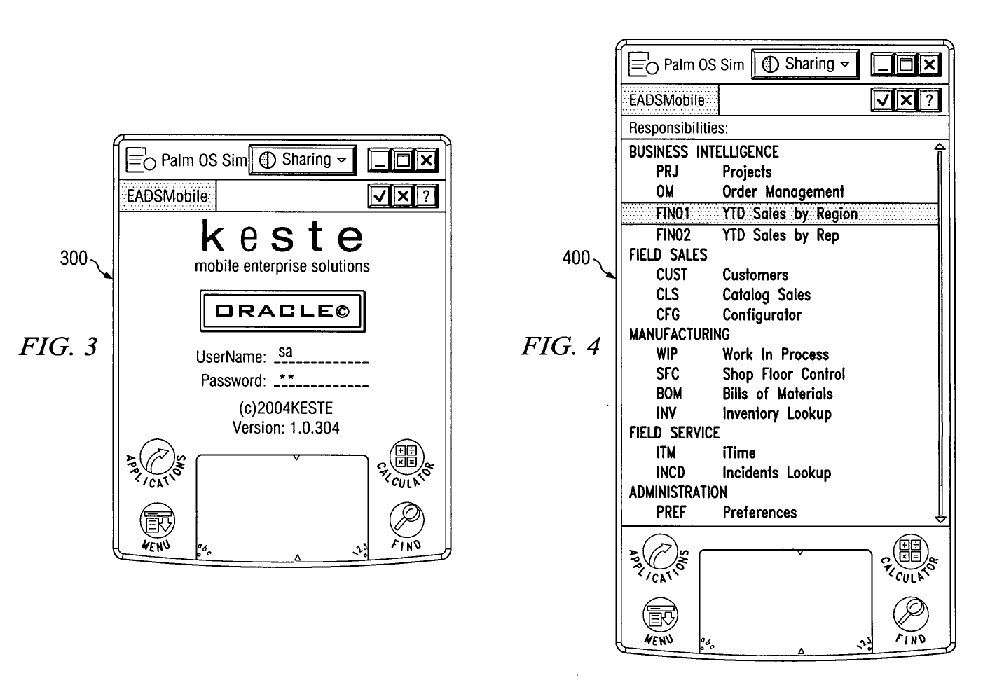

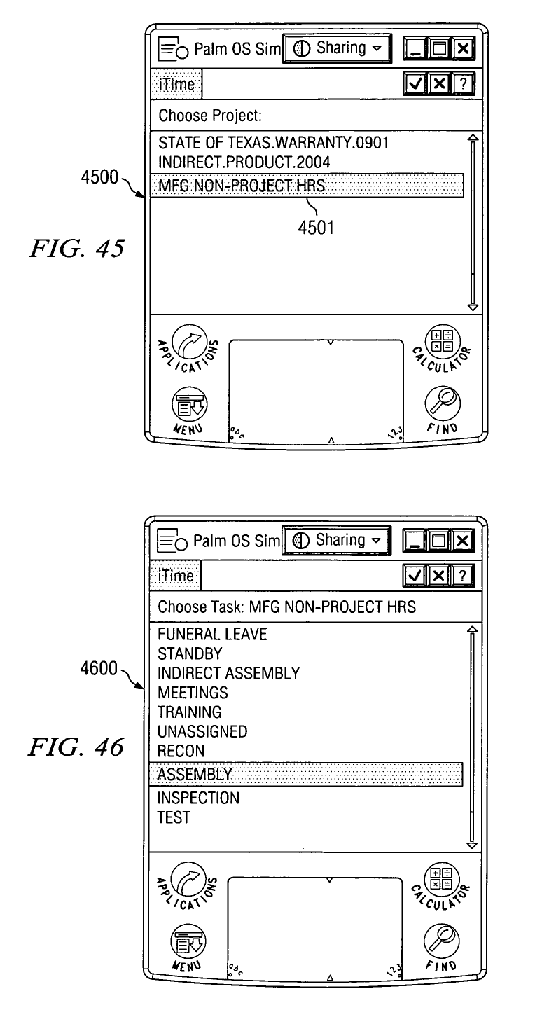

To enable the present invention, files are uploaded to the mobile client. Referring now to the UI screen shots of FIGS. 3 through 51, FIG. 3 illustrates Login Screen 300 in which a user can login into the system. A Key file contains user responsibilities. FIG. 4 illustrates a responsibilities screen 400. On this screen, available responsibilities are listed for the user. A plurality of implemented responsibilities can be listed, including Configurator, Business Intelligence, Field Sales, Field Service, Manufacturing, WIP JOBS, and Sales order Jobs.

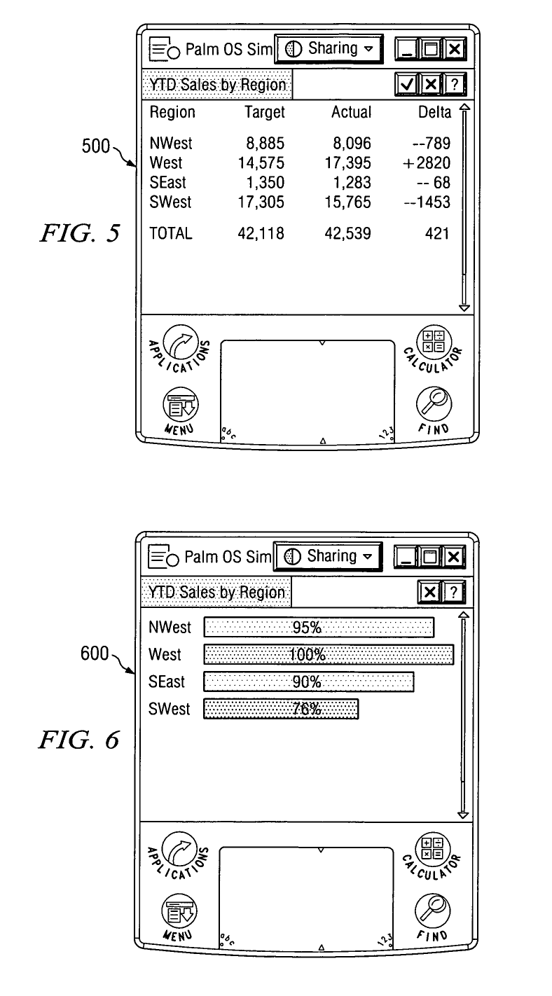

For example, FIG. 5 shows a first sales screen 500 on which Business Intelligence is provided. Text reports, for example, can be gathered from a third party business information source.

As seen in FIG. 6, a second sales screen can take a plurality of graphic formats, such as stop light charts, pie charts, and vertical bar graphs, and as seen on screen 600, horizontal bar graphs.

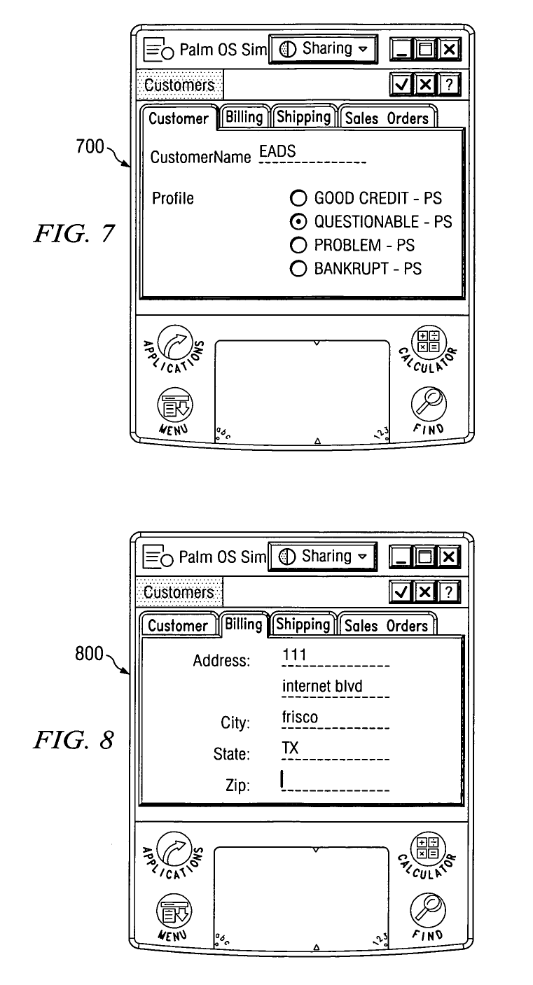

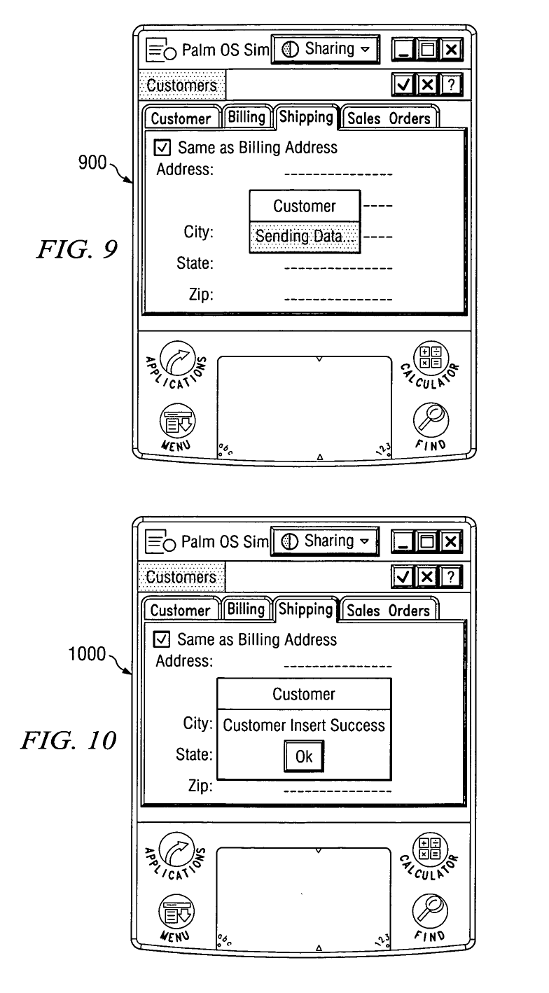

FIG. 7 provides a first customers management screen 700. Through this type of UI, a user can add new customers to the system using a variety of key fields, such as, but not limited to, name, profile, billing address and shipping address. As seen in FIG. 8, a second customers management screen 800 provides for a field to enter a billing address. As seen in FIG. 9, a third customers management screen 900 allows a user to enter a shipping address or use the same billing address. FIG. 10 provides a fourth customers management screen 1000 which illustrates how the system responds back with results, either success or failure with errors. On this screen, errors can be corrected to obtain the correct information.

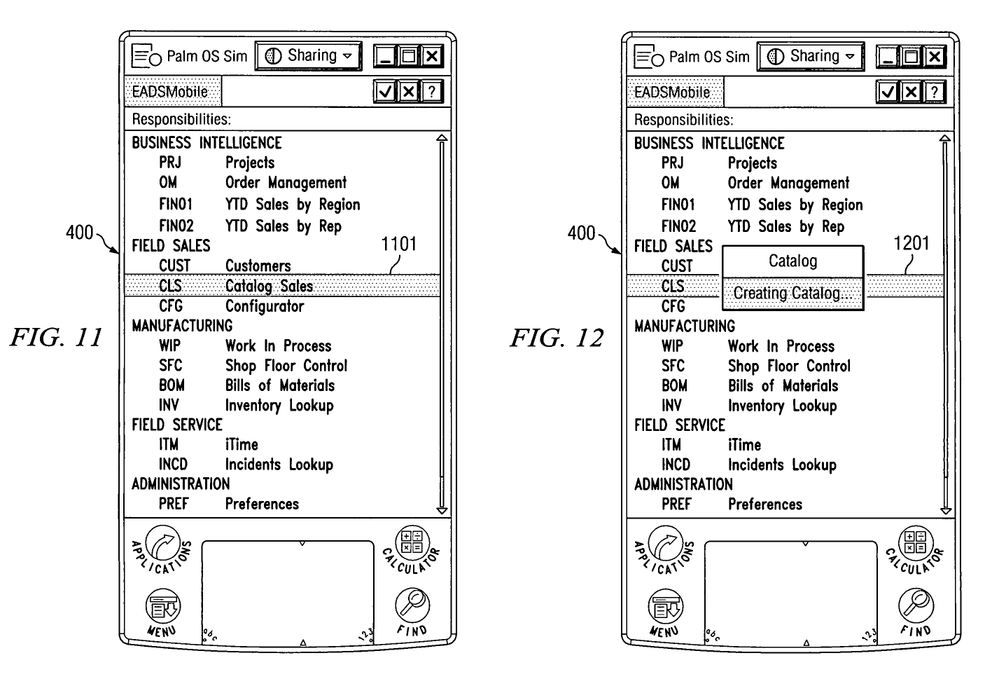

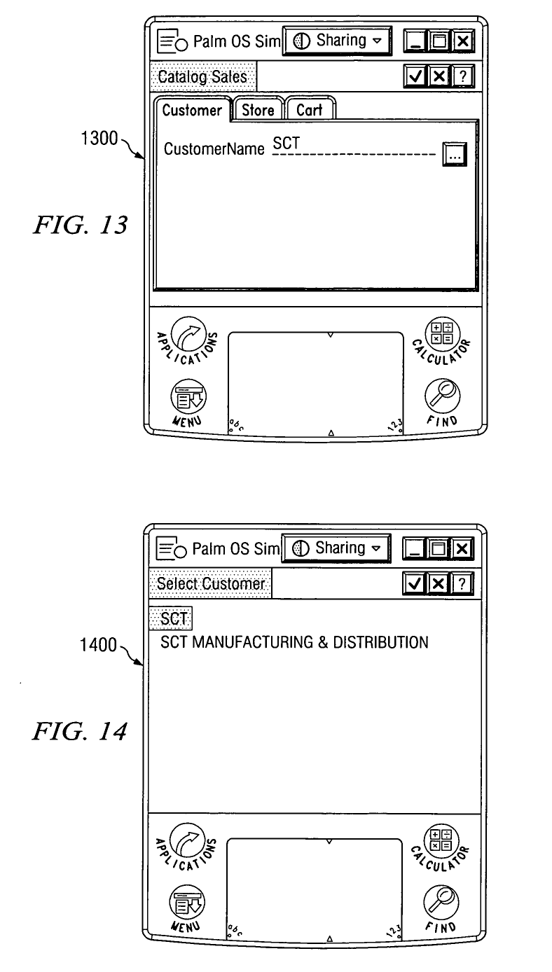

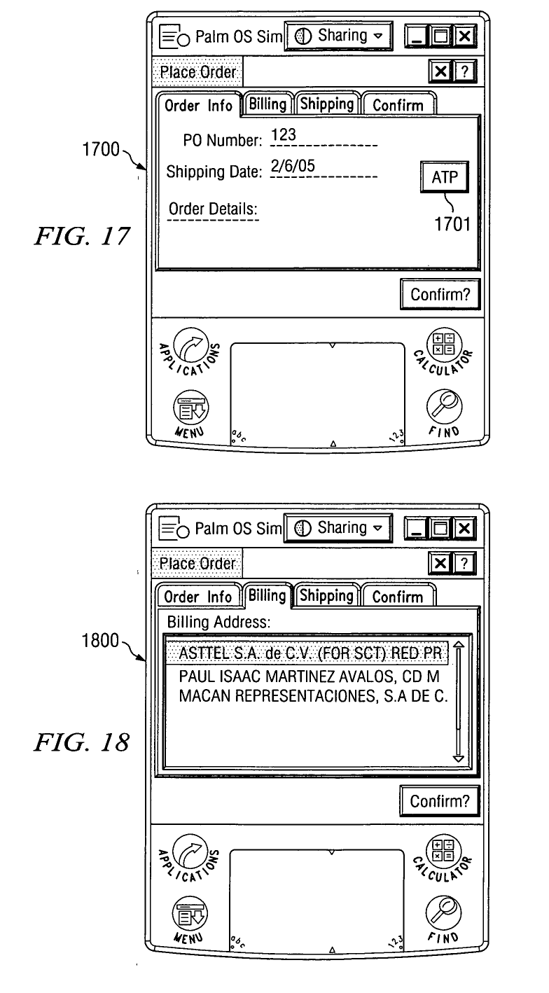

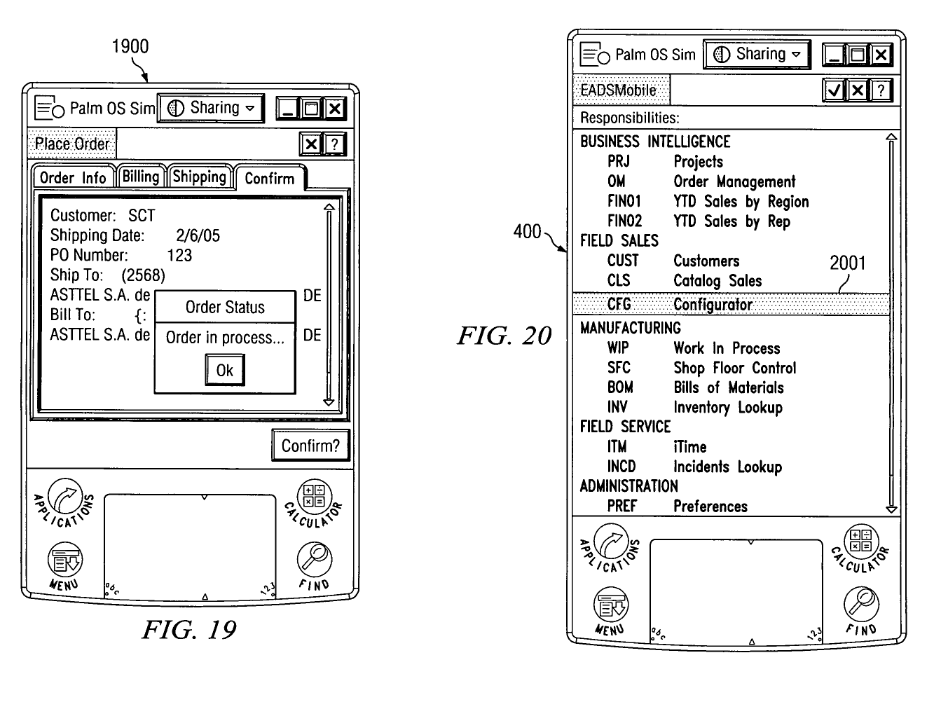

FIG. 11 shows the responsibilities UI screen 400 in which catalog sales 1101 have been highlighted. By selecting this option, as seen in responsibilities screen 400 of FIG. 12, the system extracts catalog information 1201 from the enterprise, if one does not exist on the device, otherwise the updated file from the mobile device will be used. As seen in FIG. 13, a first catalog sales screen 1300 is provided upon extraction. As seen therein, step 1 of catalog sales, invokes the Customer Module. The user can select the customer by keying in first few characters of the customer name or the user can use customer management screens to invoke new customer creation as seen in FIG. 14. The key characters are sent to the mobile gateway to retrieve the matching customers and the user can then select the customer name as seen on second catalog sales screen 1400. This returns the user to the catalog sales screen. As seen in FIG. 15, the user then chooses from the catalog, as seen in third catalog sales screen 1500 the list of items to be added to the cart. As seen in fourth catalog sales screen 1600 of FIG. 16, the user can check the cart to determine whether the items exist so that the order can be pushed into order management system. As the catalog order process progresses, the items in the cart is prepared to be placed into order management. As seen in the first place order screen 1700 of FIG. 17, the user enters the customer purchase order number, and by clicking the ATP button 1701, retrieves the date when the items can be shipped to the customer. In the second place order screen 1800 as seen in FIG. 18, the user can then select the billing address of the customer. As seen in the third place order screen 1900 of FIG. 19, after selecting shipping address, the user can confirm the order. Upon confirmation the order information is passed to the server for processing.

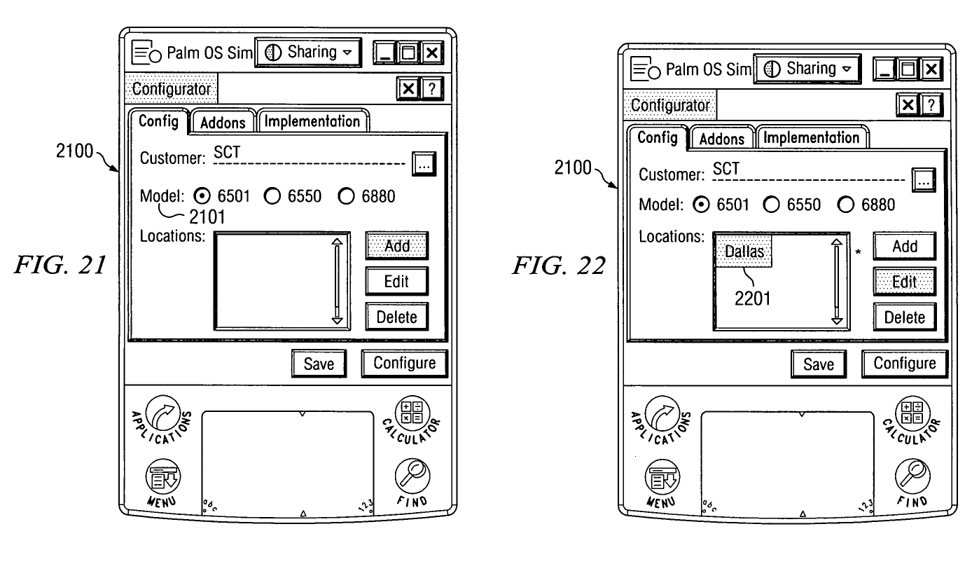

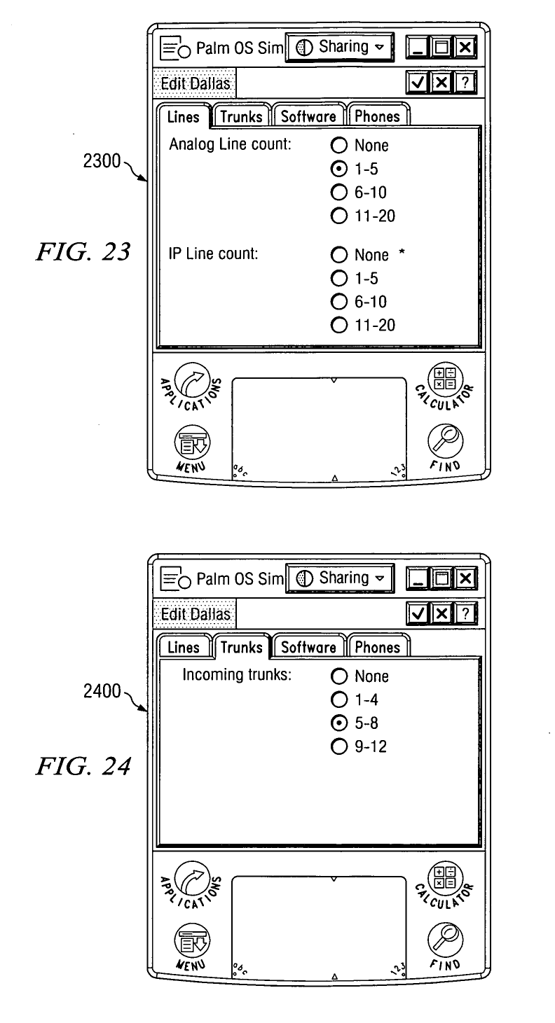

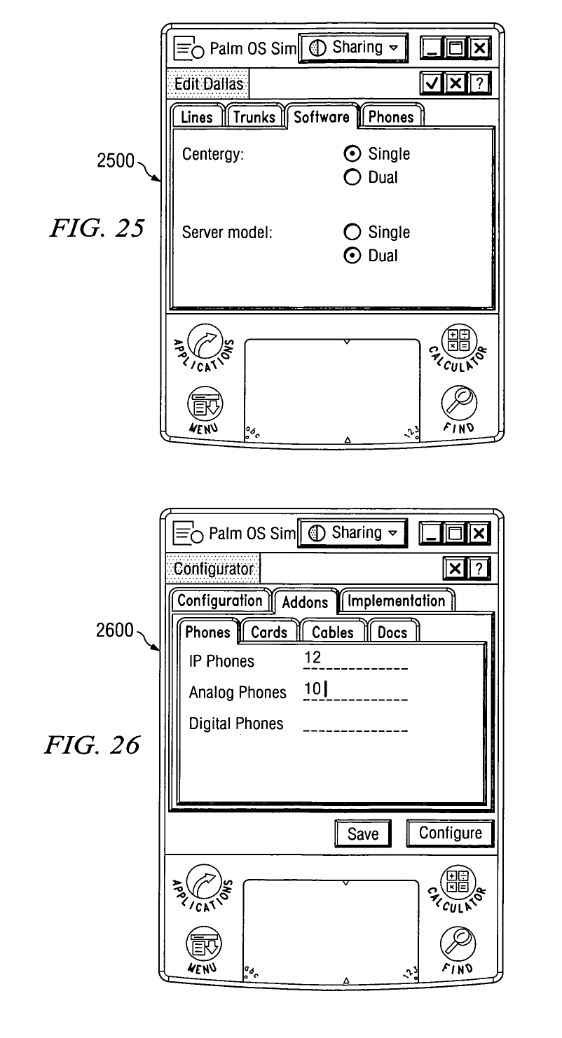

Returning to the responsibilities screen, the user can access the mobile configurator of the present invention by selecting configurator 2001 as seen in the responsibility screen 400 of FIG. 20. Referring now to the first mobile configurator screen 2100 of FIG. 21, a user can choose the customer for whom the user is building the configuration (as previously described). The user can then select a product model 2101 which has to be configured. Of course, the available models depends on the user and the application. If there is only one model, the model is defaulted. Referring now to the mobile configurator screen 2100 seen in FIG. 22, a user can add multiple multi-instance nodes 2201. In the disclosed embodiment and configuration, this is shown as multi-locations where hardware and software components are installed. As seen in FIG. 23, by selecting the location edit option via screen 2300, the mobile configurator allows the user to select the options and values required by the configuration process. As seen in screenshot 2400 of FIG. 24, by selecting via the option tabs, more option selections are made available via the mobile configurator. The tab layout 2401 on the top of the screen separates various categories of options for a guided selection of components. This is further illustrated on screen shot 2500 of FIG. 25 wherein the user can select more options via the mobile configurator. The options can be of a plurality of types, including string field, numeric field, decimal field, logic field (true/false) and list of options.

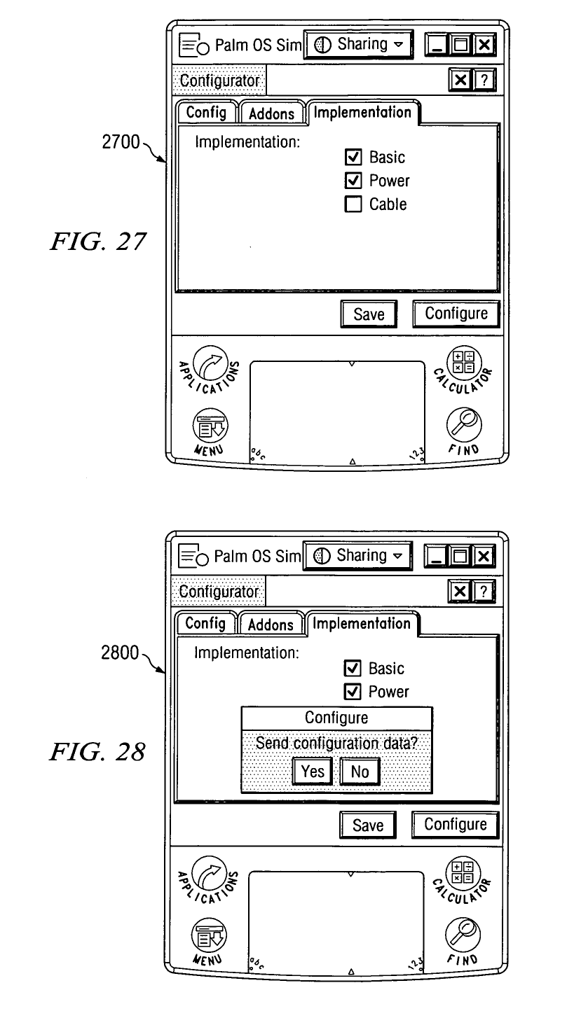

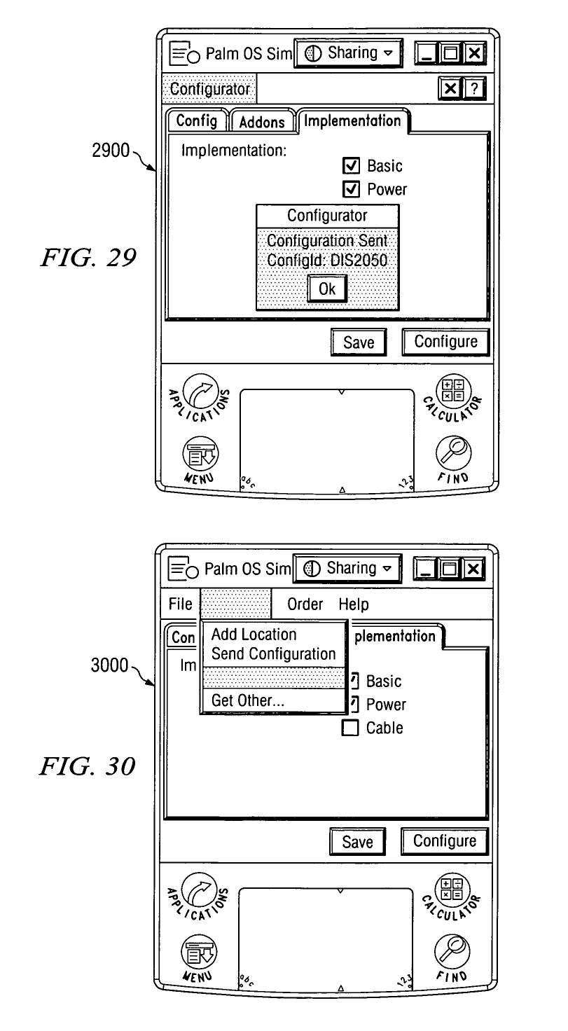

Referring to the third mobile configurator screen 2600 of FIG. 26, the user can enter add on values. These can be configurable add-on components or purchased components. The mobile gateway will have information how to handle each type of components separately. Fourth mobile configurator screen 2700 of FIG. 27, illustrates how a user can select logic fields. Fifth mobile configurator screen 2800 of FIG. 28 prompts the user to send the configuration data. If the user select yes, the configuration requirements are sent wirelessly to the mobile gateway which internally forwards them to the configurations queue for processing. As seen in the sixth mobile configurator screen 2900 of FIG. 29, once the mobile gateway processes and accepts the information for configuration processing, it sends back an identifier for retrieval of result sets. As seen in mobile configurator screen 3000 of FIG. 30, the user can access the user menu and select Get configuration to retrieve the completed configuration from the server.

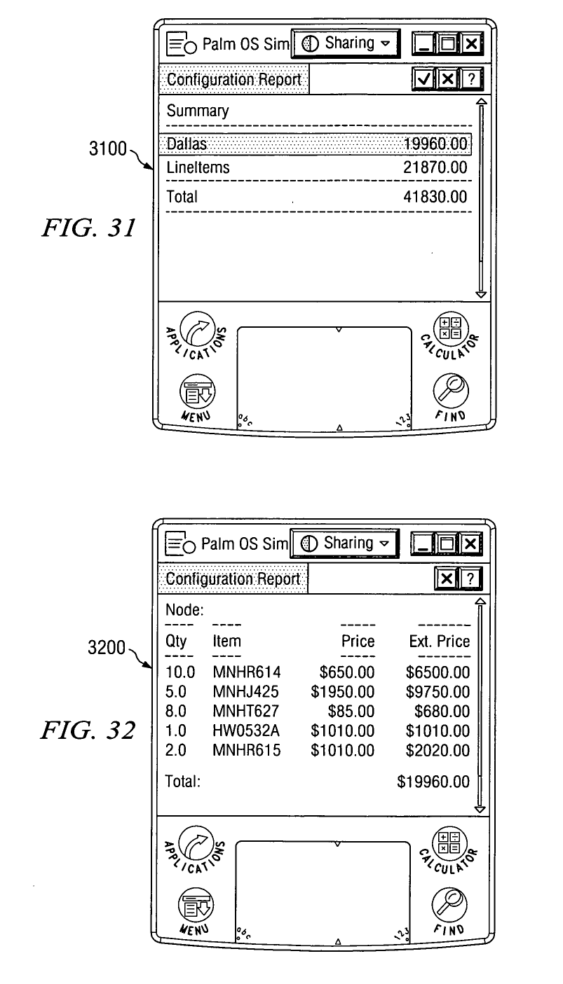

In a first configuration report screen 3100 as seen in FIG. 31, the user can review the items retrieved. The configuration report can show the breakup with each subset. Further, the total cost and price information can be displayed based on the user's view policy. Furthermore, as seen in the second configuration report screen 3200 as seen in FIG. 32, each subset can be drilled down to see detailed price and cost information.

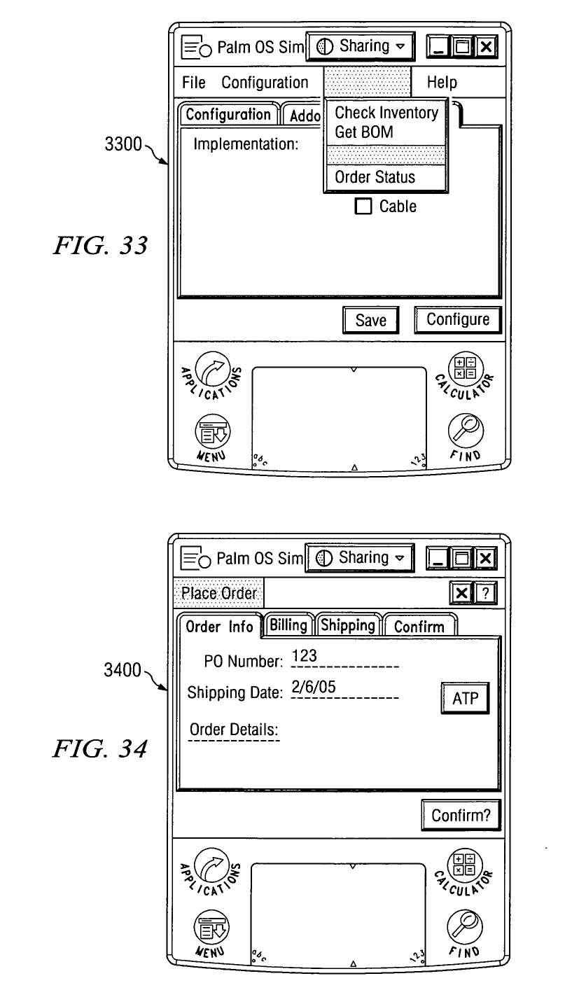

The mobile configurator to order process is seen in the screen shot 3300 of FIG. 33. As seen therein, once the configuration is complete, the user can click place order on the user menu to take it to the order process.

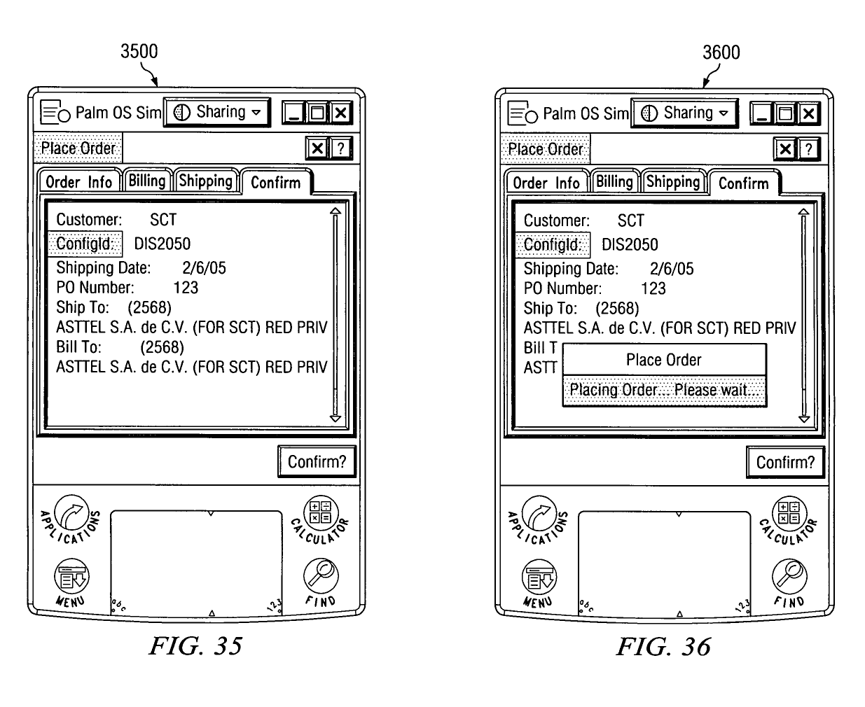

Continuing the configurator to order process, a user returns to a place order screen 3400 as seen in FIG. 34. Therein, a user can enter the purchase order number of a customer in this order process module and retrieve the ATP date for the configured order. As seen in FIG. 35, after selecting the billing and shipping addresses, the order is ready to be confirmed. Note in screen shot 3500 that the configuration id shows up in the list. The mobile gateway provides and manages the order process with the information necessary to progress the order. As seen in screen shot 3600 of FIG. 36, the process module places the order in the system through the mobile gateway.

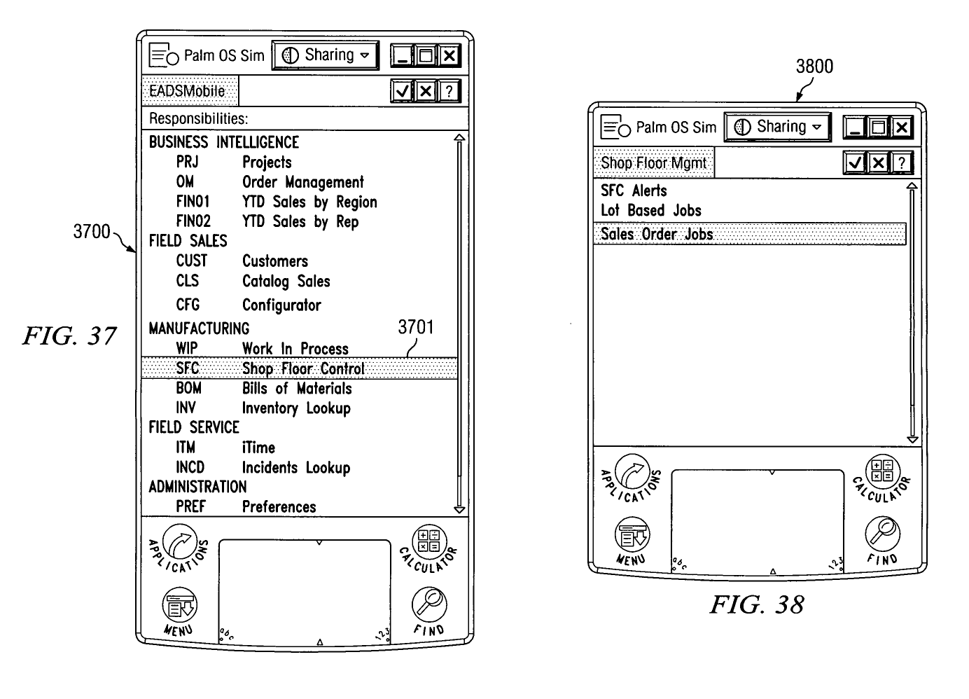

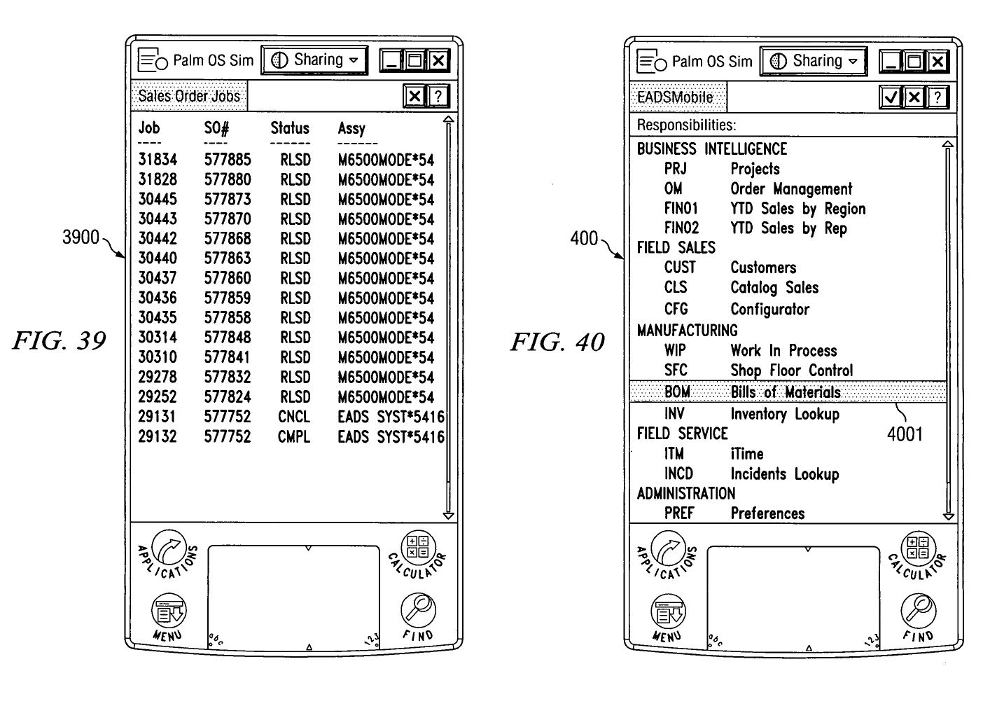

Referring now to the mobile manufacturing process, the shop floor control module can be accessed from the responsibilities UI 3700 as seen in FIG. 37. As seen therein, the user can select the shop floor control module 3701 from the main menu. From there, in the mobile manufacturing process, the user can select sales order jobs to review the jobs currently in the manufacturing queue after the configured order and catalog order process as seen in shop floor management screen shot 3800 of FIG. 38. Upon selection, the sales order jobs screen 3900 of FIG. 39 can show the jobs with a plurality of information, including but not limited to Job number, sales order number, status such as released, cancelled or completed, and assembly number.

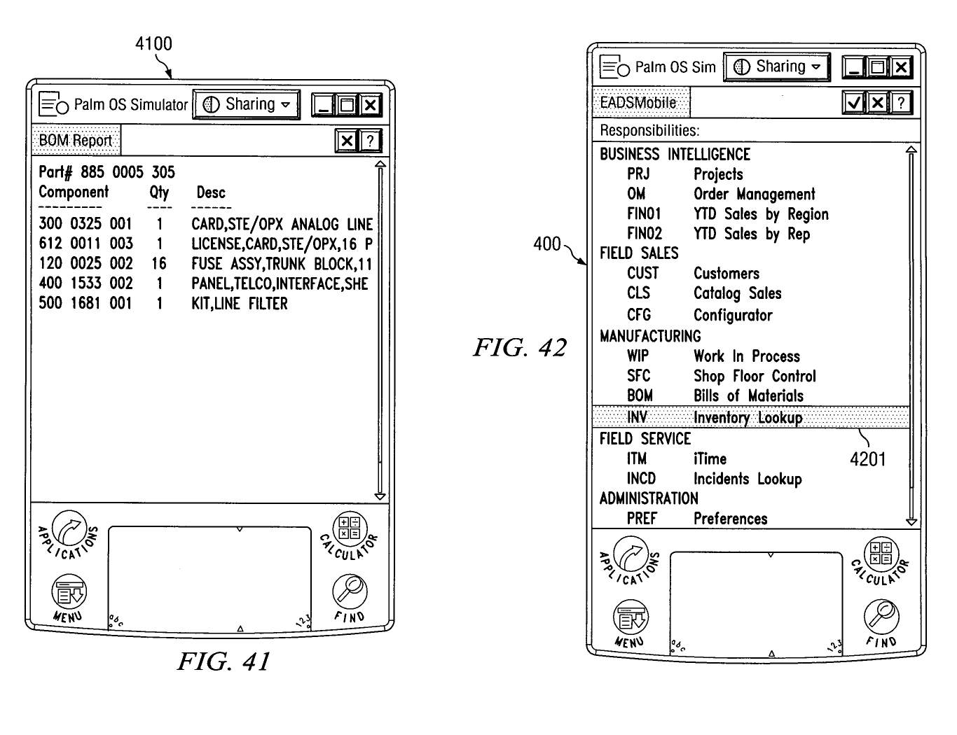

Referring now to the bill of materials process, the bills of materials control module can be accessed from the responsibilities UI 400 as seen in FIG. 40. As seen therein, the user can select the bills of materials module 4001 from the main menu. In the BOM report screen 4100 of FIG. 41, a user can select the part number for which the users requires the system to retrieve the list of materials. The mobile gateway translates this information and shows the list in the device screen 4100.

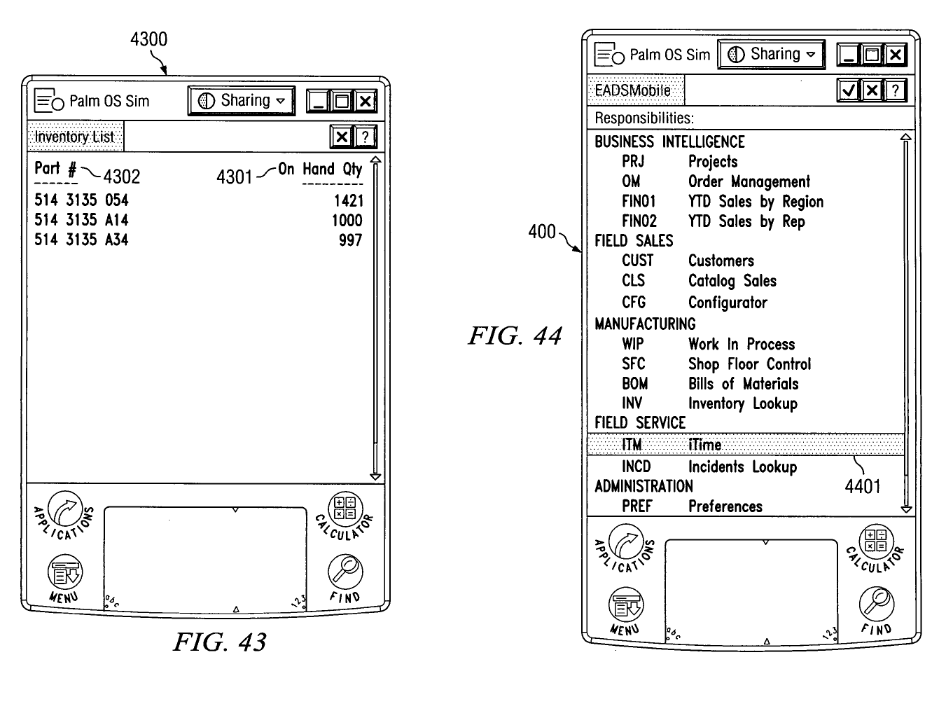

Referring now to the inventory lookup process, the inventory lookup control module can be accessed from the responsibilities UI 400 as seen in FIG. 42. At this screen the user can select the inventory lookup option 4201 in the main menu. As seen in the inventory list screen 4300 of FIG. 43, the on-hand quantity 4301 for each part 4302 is shown for the category selected. The information about the parts such as warehouse id and the like, can be displayed based on the user setup.

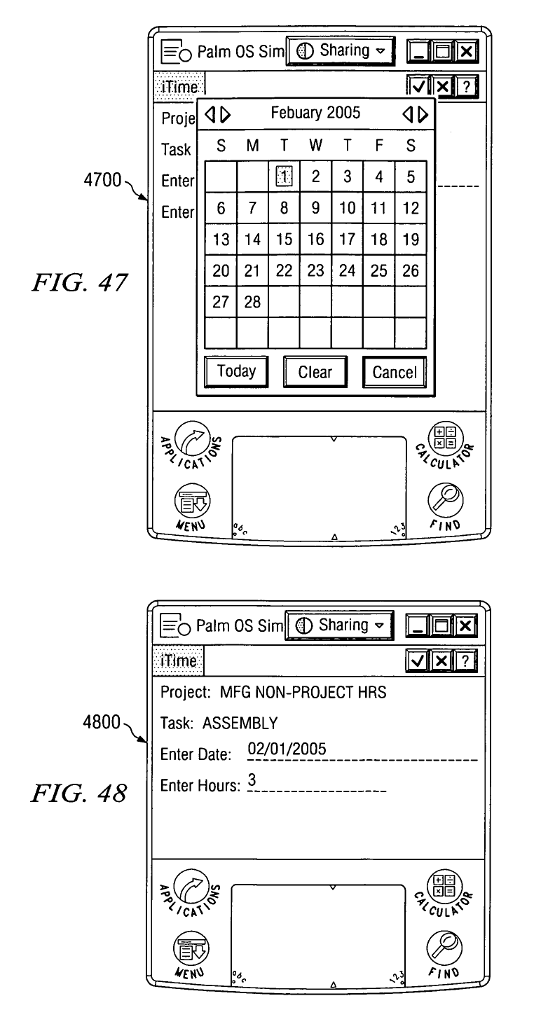

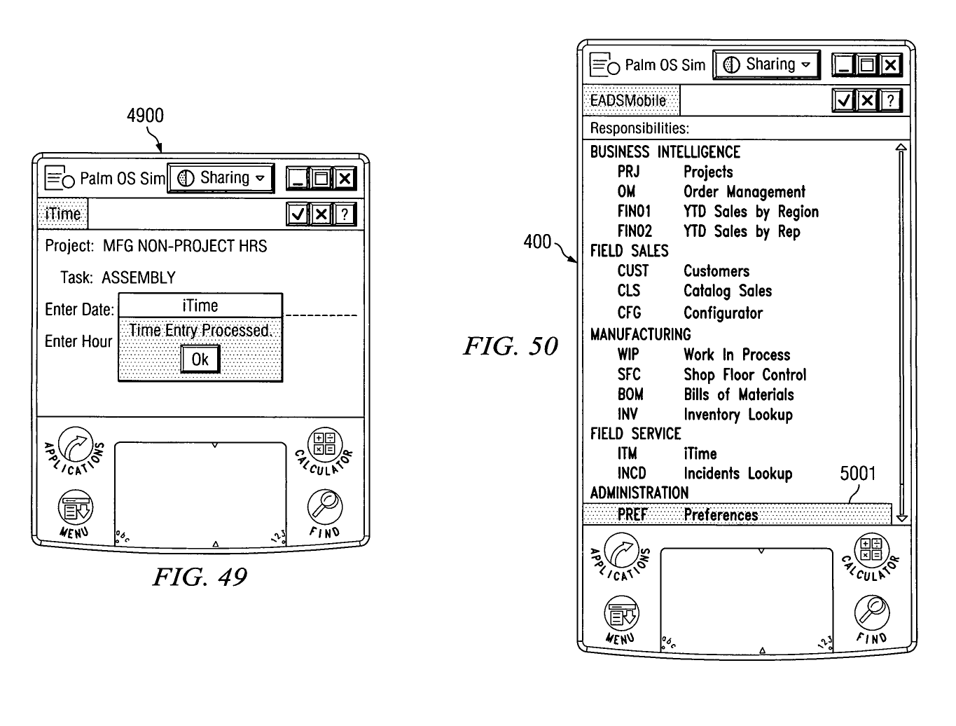

Referring now to the projects/time capture process, the iTime control module can be accessed from the responsibilities UI 400 as seen in FIG. 44. As seen therein, the user can select the iTime option 4401 from the main menu. Upon selection the system wirelessly retrieves the list of projects 4501 the user is working on as seen on screen shot 4500 of FIG. 4500. This information interfaces with the projects module. As seen in FIG. 46, depending on the project, the system retrieves the list of tasks for the selected project. As seen in screen shot 4600, the user can choose a task for which time has to be captured. Furthermore, and referring to screen shot 4700 of FIG. 47, the user can select the date on which work was performed. As seen in screen shot 4800 of FIG. 48, the user can enter the number of hours to charge time. When the user clicks OK to process the time entry, as seen on screen shot 4900 of FIG. 49, this information is updated on the system through the mobile gateway

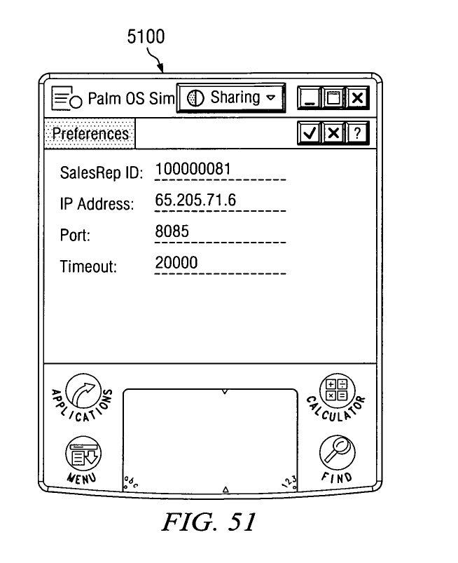

Referring now to the user setup/administration process, the user setup/administration module 5001 can be accessed from the responsibilities UI 400 as seen in FIG. 40. As seen therein, the administrator or user can select the preferences option from the main menu to setup preferences including the connection info. Further, as seen in screen shot 5100 of FIG. 51, the administrator or user can setup a plurality of information, including the following: sales person ID, IP address, port, and timeout info. This information is usually set up in the user's key file. The preference setup field information is adapted to increase as the number of applications increases.

The method, system and computer program shown and described herein is only exemplary. Even though a preferred embodiment and advantages of the present invention have been set forth in the foregoing description together with details of the invention, the disclosure is illustrative only and changes may be made within the principles of the invention to the full extent indicated by the broad general meaning of the terms used in herein and in the attached claims.

1. A system comprising at least one wireless mobile configurator adapted to interface at least one mobile device through at least one mobile gateway to at least one back-end.

2. The system of claim 1, in combination with at least one mobile device and at least one mobile gateway.

3. The system of claim 2, wherein the at least one mobile device is a wireless mobile device.

4. The system of claim 2, further comprising the at least one wireless mobile configurator having a configurator engine and a CZQueue component resident in the wireless mobile configurator between the mobile gateway and the configurator engine.

5. The system of claim 4, wherein the CZQueue component further comprises a model loader, asynchronous messaging client and a pool of model contexts.

6. The system of claim 5, wherein the CZQueue component initializes the configurator engine and creates pool of model contexts.

7. The system of claim 6, wherein the mobile gateway is adapted to receive inputs from the at least one mobile device and transmit said inputs to the CZQueue component.

8. The system of claim 7 wherein the at least one mobile device is adapted to send a sync request to configure a product or a service.

9. The system of claim 8, wherein the CZQueue component loads the appropriate model using a model context from the pool.

10. The system of claim 9, wherein the model context is associated with the mobile device for one session.

11. The system of claim 10, wherein, for each user action, the mobile device generates a request to validate user inputs;
the CZQueue component maps each user request against the corresponding model context and;
the CZQueue updates the model inputs.

12. The system of claim 11, further comprising the configurator engine being adapted to validate the change in input;
the configurator engine being adapted to set an error condition or generate outputs as per defined rules;
the CZQueue component being adapted to retrieve the result set; and
the CZQueue component being adapted to send a reply to the mobile device via the mobile gateway.

13. The system of claim 1, in combination with a backend system.

14. The system of claim 13, wherein the backend comprises an enterprise software system.

15. A method of engaging in a business process, comprising using a mobile device to communicate with a backend through a mobile gateway.

16. The method of claim 15, wherein the mobile device is coupled to the mobile gateway using the Internet over a communications channel.

17. The method of claim 16, wherein the communications channel is a wireless communications channel.

18. The method of claim 15, wherein the business process is one from the group consisting of developing a price quotation; checking inventory availability; placing an order; checking work in process; providing a shipping date; checking a delivery date; and generating model configurations and costs.

19. The method of claim 18, wherein the process of generating model configurations and costs is implemented using a configuration engine.

20. A computer program comprising at least one wireless mobile configurator adapted to interface at least one mobile device through at least one mobile gateway to at least one back-end.
